(19) United States
(12) Patent Application Publication
(10) Pub. No.: US 2019/0127614 A1
(43) Pub. Date: May 2, 2019

(54) AN AQUEOUS POLYMER DISPERSION FOR ADHESIVES

(71) Applicant: WACKER CHEMIE AG, Muenchen (DE)

(72) Inventors: Zijian ZHANG, Shanghai (CN); Ping ZHANG, Shanghai (CN); Haoqing SUN, Shanghai (CN); Yan WU, Shanghai (CN); Lingyun HUANG, Shanghai (CN)

(73) Assignee: WACKER CHEMIE AG, Muenchen (DE)

(21) Appl. No.: 16/093,643

(22) PCT Filed: Apr. 12, 2017
(86) PCT No.: PCT/CN2017/080250

§ 371 Date: Oct. 14, 2018

(30) Foreign Application Priority Data
Apr. 15, 2016 (CN) 201610234548.1

(51) Int. Cl. C09J 129/14; C09J 11/08; A24C 5/47; A24C 1/34

(52) U.S. Cl. CPC C09J 129/14; A24C 1/34; A24C 5/472; C09J 11/08

(57) ABSTRACT

The invention relates to aqueous polymer dispersions obtained by emulsion polymerization in the presence of a stabilizing 4system containing polyvinyl alcohols (PVOH). More specifically, the invention relates to adhesive formulations containing aqueous polymer dispersions, and to the use of said adhesive formulations as adhesives for cigarette making and packaging.

### FIELD OF THE INVENTION

The invention relates to aqueous polymer dispersions obtained by emulsion polymerization in the presence of a stabilizing system containing polyvinyl alcohols (PVOH). More specifically, the invention relates to adhesive formulations containing aqueous polymer dispersions, and to the use of said adhesive formulations as adhesives for cigarette making and packaging.

### BACKGROUND OF THE INVENTION

Adhesives are one of the most important raw and auxiliary materials in the manufacturing of cigarettes and involved in many cigarette manufacturing processes, including seaming, tipping, filter rod centerline, packaging and Al-foil laminating adhesives. Currently, domestic mainstream cigarette making machines run generally at a single-gun speed of 7,000 cigarettes/minute or so (some new cigarette making machines can reach 10,000-16,000 cigarettes/minute). That is, cigarettes are rolled out at 500 meters/minute or so. For example, for seaming adhesives, the time between applying the adhesive to the cigarette paper and rolling out the cigarette rods is less than 0.1 second, and the time needed for drying is less than 0.1 second; otherwise cigarette making machines would stop working due to the “cigarette rod break-out”. Therefore, cigarette adhesives need to have excellent adhesion and rheological properties.

Aqueous polymer dispersions containing vinyl esters have been widely used in adhesives and coatings. For example, stabilized aqueous polymer dispersions containing vinyl acetate polymers are used as adhesives for paper packaging and converting. The adhesives are often prepared with polymers synthesized by emulsion polymerization, and cure or harden to form a film at room temperature upon evaporation or removal of the aqueous medium. With excellent adhesion and rheological properties, common polyvinyl acetate emulsion adhesives have been widely used in cigarette industry at home and abroad. High speed of up to 14,000-16,000 cigarettes/minute of new cigarette making machines requires adhesive combinations with high solids content and stable viscosity to be used to ensure easy coating and quick drying on paper.

Further requirements for high speed cigarette adhesives are related to their rheological properties, such as viscosity and its shear rate dependence, their shelf life or stability, including their colloidal stability in general and their viscosity stability in particular. Additionally, the adhesive shall provide a high setting speed of paper bond on the one hand, and on the other hand it shall provide a sufficient long open time.

Many important and desired properties of a high speed cigarette adhesive depend on:

(1) the selection of kind and/or quantity of polyvinyl alcohol polymers or their mixtures in stabilizing system; and

(2) the aqueous polymer composition, in particular kind and/or amount of the used monomers in emulsion polymerization;

In addition, it is known that

(3) the process of emulsion polymerization;

(4) kind and amount of additional compounds used during emulsion polymerization, e.g. for initiation, chain transfer, additional colloidal stabilization, or for other purpose; and

(5) kind and amount of compounds used by post addition in adhesive combinations may have a major influence on the properties of the adhesives.

EP0851015B1 discloses vinyl ester-ethylene copolymers polymerized in the presence of partially hydrolyzed polyvinyl alcohol, followed by addition of 85-100 mol % hydrolyzed polyvinyl alcohol for use as an adhesive.

CN101687958B discloses a formaldehyde-free aqueous polymer dispersion providing improved heat resistance, which is obtained by emulsion copolymerization of comonomers and vinyl ester monomers in the presence of fully hydrolyzed polyvinyl alcohol having an average degree of hydrolysis above 95 mol %, wherein the comonomers include (meth)acrylamides. Based on total used monomers, the aqueous polymer dispersion comprises 2 to less than 12% by weight of fully hydrolyzed polyvinyl alcohol, wherein the fully hydrolyzed polyvinyl alcohol has an average degree of hydrolysis above 98 mol % up to 99.95 mol %. And said polymerization does not involve partially hydrolyzed PVOH having an average degree of hydrolysis up to 95 mol %.

CN103732711A discloses an aqueous dispersion of vinyl ester/ethylene copolymers, which has a very low formaldehyde level of less than about 5.0 ppmw as determined by ISO-15173 and is suitable for use in adhesives for tobacco and food products. Such aqueous dispersion is prepared by emulsion copolymerization of a monomer mixture comprising a vinyl ester (e.g. vinyl acetate), ethylene and a polyvinyl alcohol stabilizing system and a free radical redox polymerization initiator system. The stabilizing system for the monomer mixture comprises polyvinyl alcohol preferably having a degree of hydrolysis of at least about 97 mol %.

CN104704076A provides an adhesive combination comprising an aqueous polymer dispersion produced usually by polymerization of a monomer composition comprising vinyl esters in the presence of polyethylene alcohol protective colloids, where suitable polyvinyl alcohol has a degree of hydrolysis of 60-100 mol % and a viscosity of 4% aqueous solution at 20° C. of 2-70 mPa·s, especially 4-40 mPa·s. The amount thereof, based on the total amount of monomers used, is usually 0.1-5 parts by weight. However, the invention of CN104704076A aims, by using plasticizers containing esters of polyols and linear or branched aliphatic monocarboxylic acid having 3-20 carbon atoms, such as hexanoate ester-based plasticizers, to reduce the level of said plasticizers in packaging adhesives by at least 40% and, at such reduced loadings, to keep the required properties of the adhesives at the same or improved levels.

No adhesive based on the existing technologies meeting the needs of high speed operations with the new high speed cigarette making machines has emerged so far. When an adhesive stays as an aqueous dispersion before cured, it shall have certain rheological properties to allow for running efficiently on high speed machines. It also shall meet other requirements, in particular, those related to smoking quality standard. In addition, the adhesive should not produce toxic substances in cigarette smoke.

### SUMMARY OF THE INVENTION

As used herein, unless otherwise specified, the term “polymer(s)” represents a polymer prepared with one or more different polymers, such as copolymers, terpolymers, tetrapolymers and pentapolymers, or any atactic polymers, block polymers, graft polymers, sequence polymers or gradient polymers.

As used herein, the term “wt. %” represents percentage by weight.

As used herein, the term “mol %” represents Mole percentage.

Present invention relates to an use of an aqueous polymer dispersion in mechanical adhesive applying processes, wherein said dispersion is obtained by emulsion copolymerization of a monomer mixture comprising a vinyl ester, a stabilizing system comprising polyvinyl alcohol and a free radical redox polymerization initiator system, wherein the dosage of polyvinyl alcohols in said dispersion is between 6.6 wt. %-35 wt. %, preferable between 7 wt. %-20 wt. %, based on all the monomers in the dispersion.

The use according to above, wherein the solids content of said dispersion is greater than or equal to 58 wt. %, preferably between 58%-60 wt. %, based on said dispersion.

Mechanical adhesive applying processes are: applying adhesives containing aqueous polymer dispersions to the substrate generally by machine application methods such as nozzle application systems or roll technologies.

The use according to above, wherein, tested according to DIN 53019, the dispersion has a viscosity that keeps greater than or equal to 2,000 mPa·s as the shear rate increases continuously evenly from 0 to 800 s⁻¹ during the time from 0 to 300 s.

The use according to above, wherein, as the shear rate increases continuously from 600 s⁻¹ to 800 5⁻¹, the absolute value of the average rate of change in the viscosity of said dispersion is less than or equal to 50, preferably less than or equal to 30.

The rheological curve of the dispersion in the invention obtained by testing according to DIN 53019 shows that: at the shear rate of γ1, the corresponding viscosity is η1; at the shear rate is γ2, the corresponding viscosity is η2. As a result, when the shear rate changes continuously in the range between γ1 and γ2, the absolute value of the average rate of change in the viscosity of the dispersion is: |(η1-η2)/(γ1-γ2)|. The absolute value of the average rate of change in the viscosity of the dispersion can be used to characterize the trend of the rheological curve. A smaller absolute value of the average rate of change indicates a smoother curve and more stable viscosity of the dispersion.

The use according to above, wherein the Brookfield viscosity of the dispersion, measured at 25° C. using Brookfield viscometer RVDV-II+P with spindle #4 at 20 rpm, is greater than or equal to 2,000 mPa·s, preferably 2,000-6,000 mPa·s, and more preferably 2,000-5,000 mPa·s.

The use according to above, wherein greater than or equal to 48 wt. % of said polyvinyl alcohols are added in the Initial feeding step and/or Polymerizing process, based on the total amount of polyvinyl alcohols.

The use according to above, wherein 100 wt. % of said polyvinyl alcohols are added in the Initial feeding step and/or Polymerizing process, based on the total amount of polyvinyl alcohols.

The use according to above, wherein said dispersion is a copolymer of vinyl esters/ethylene dispersion.

The use according to above, wherein said dispersion is a copolymer of vinyl acetate/ethylene dispersion.

The use according to above, wherein said dispersion containing:

(1) one or more low molecular weight polyvinyl alcohols, which is/are partially hydrolyzed polyvinyl alcohol(s) having a degree of hydrolysis of 85-95 mol % and a Hoeppler viscosity of 3-6 mPa·s at a concentration of 4% by weight at 25° C.;

(2) one or more medium to high molecular weight polyvinyl alcohols, which is/are partially hydrolyzed polyvinyl alcohol(s) having a degree of hydrolysis of 85-95 mol % and a Hoeppler viscosity of 10-33 mPa·s at a concentration of 4% by weight at 25° C.;

wherein the mass ratio of the low molecular weight polyvinyl alcohols to the medium to high molecular weight polyvinyl alcohols is greater than or equal to 6.5, preferably between 6.5-20.

The use according to above, wherein the low molecular weight polyvinyl alcohol is PVOH 04/88.

The use according to above, wherein the dispersion contains no anionic surfactants.

The use according to above, wherein the dispersion contains no nonionic surfactants.

The use according to above, wherein the dried substance of said aqueous polymer dispersion has a Tg of 12° C.˜18.5° C.

An adhesive combination which containing said dispersions according to any of above, wherein said adhesive combination is used as adhesives for cigarette making and packaging.

Main Co-Monomers

The aqueous polymer in the invention is a copolymer containing vinyl esters and ethylene, wherein the vinyl ester(s) used is/are usually vinyl ester(s) of saturated carboxylic acids having 1-20, typically 2-8, carbon atoms, especially vinyl acetate, and wherein the above-mentioned vinyl ester is at least one vinyl ester of mono- or di-carboxylic acid having up to 20 carbon atoms. Suitable vinyl esters include vinyl formate, vinyl acetate, vinyl propionate, vinyl butyrate, ethyl isobutyrate, vinyl valerate, vinyl 2-ethylhexanoate, isooctanoic acid ethenyl ester, ethyl pelargonate, vinyl decanoate, vinyl pivalate, vinyl versatate, vinyl laurate, vinyl stearate, vinyl benzoate, and mixtures thereof.

Preference is given to vinyl acetate, which will comprises from about 50% to about 99% by weight of copolymers, based on the total weight of monomers. The ethylene component is generally present in the copolymers in an amount from about 1% to about 40% by weight, e.g. from about 11% to about 18% by weight of the total monomers.

Optional Co-Monomers

In addition to vinyl ester and ethylene, comonomer mixtures can contain the following one or more additional functional monomers added to improve the properties of final copolymer dispersions. Such optional functional comonomers can include ethylenically unsaturated acids, such as mono- or di-carboxylic acid, sulfonic acid or phosphonic acid. As alternatives to free acids, their salts can also be used, preferably alkaline metal salts or ammonium salts. Examples of optional functional comonomers of this type include monoesters of acrylic acid, methylacrylic acid, croton acid, maleate, fumarate, itaconic acid, vinylsulfonic acid, vinylphosphonic acid, styrenesulfonic acid, maleic and/or fumaric acid and itaconic acid with monohydric aliphatic saturated alcohols of chain lengths C₁-C₁₈, as well as their alkaline metal and ammonium salts, or (meth) acrylic esters of sulfoalkanols, an example herein is sodium 2-sulfoethyl methacrylate.

Other types of suitable optional functional comonomers include ethylenically unsaturated comonomers having at least one from amide-, epoxy-, hydroxy-, trialkoxysilanes- or carbonyl group. Particularly suitable are ethylenically unsaturated epoxy compounds, such as glycidyl methacrylate or glycidyl acrylate. Also suitable are carbonyl compounds, including methacrylic acid and acrylic acid C₁-C₉ hydroxyalkyl esters, such as n-hydroxyethyl esters, n-hydroxypropyl esters or n-hydroxybutyl esters of acrylic acid and methacrylic acid. Other suitable functional comonomers include amides of unsaturated carboxylic acid, such as acrylamide or methacrylamide.

Optional functional comonomers can be incorporated into the vinyl ester/ethylene emulsion copolymer of the aqueous dispersion herein in an amount of up to about 5% by weight, based on the main comonomers in the copolymer. More preferably, the optional functional comonomers can comprise from about 0.5% to about 2% by weight, based on the total main comonomers in the copolymer.

Stabilizing System

In the invention, the stabilizing system used to stabilize the aqueous emulsion of monomers during polymerization and the aqueous polymer dispersion formed thereby is combination based on one or more polyvinyl alcohols and said combination forms part of the aqueous polymer dispersion.

In the invention, the stabilizing system used for preparing aqueous polymer dispersions contains one or more low molecular weight polyvinyl alcohols having at least a degree of hydrolysis of 85 mol %. The aqueous polymer dispersion herein can also contain fully hydrolyzed low molecular weight polyvinyl alcohols and medium to high molecular weight polyvinyl alcohols, i.e. those with a degree of hydrolysis ≥98 mol %.

The term “polyvinyl alcohol” as used here is defined as unmodified or standard polymers obtained by hydrolysis or saponification of vinyl acetate homopolymer, as described by F. L. Marten and C. W. Zvanut in “Polyvinyl Alcohol-Developments”, C. A. Finch (Ed.), Wiley, Chinchester, 1992 (Reference [2]). The end groups of initiators resulting from the free radicals used in the compound formation in the early stage of polymerization of vinyl acetate are largely ignored, as long as they do not contain special functional groups.

Polyvinyl alcohol polymers differ in molecular weight or molecular weight distribution, in degree of hydrolysis or in hydrolysis distribution, or in other words in residual content of acetyl groups, and in sequence-length distribution or “blockiness” of residual acetyl groups.

The traditional method of measuring the molecular weight of a polyvinyl alcohol is using a Hoppler viscometer to measure the Hoppler viscosity of the aqueous solution of said polyvinyl alcohol with a concentration of 4% by weight at 25° C. (unless otherwise specified, the viscosity of polyvinyl alcohols in the invention is measured under these testing conditions). As a result, said low molecular weight polyvinyl alcohols are those with Hoppler viscosity of 3-6 mPa·s at a concentration of 4% by weight, and said medium to high molecular weight polyvinyl alcohols are those with Hoppler viscosity of 10-33 mPa·s at a concentration of 4% by weight.

Partially hydrolyzed low molecular weight polyvinyl alcohols commercially available usually include goods known by the common name of PVOH 04/88 and PVOH 05/88, specific examples being BP 04/88 and BP 05/88 supplied by ChangChun PetroChemical, Co. Ltd. BP 04/88 has a degree of hydrolysis of about 86-89 mol % at 20° C. and a Hoppler viscosity of about 4-5 mPa·s at a concentration of 4% by weight. For BP 04/88, the corresponding weight average molecular weight is about 21,000-27,000 g/mol. Another partially hydrolyzed low molecular weight polyvinyl alcohol commercially available is BP 05/88, also supplied by ChangChun PetroChemical, Co. Ltd. BP 05/88 has a degree of hydrolysis of about 86-89 mol % at 20° C. and a Hoppler viscosity of about 5-6 mPa·s at a concentration of 4% by weight. For BP 05/88, the corresponding weight average molecular weight is about 27,000-32,000 g/mol.

Partially hydrolyzed polyvinyl alcohols with relatively medium to high molecular weight usually include goods known by the common name PVOH 25/88, a specific example being BP 17/88 supplied by ChangChun PetroChemical, Co. Ltd. BP 17/88 has a degree of hydrolysis of about 86-89 mol % at 20° C. and a Hoppler viscosity of about 21-26 mPa·s at a concentration of 4% by weight. For BP 17/88, the corresponding weight average molecular weight is about 84,000-89,000 g/mol.

Redox Initiator System

The monomer mixtures which are polymerized to form the aqueous copolymer dispersions of the invention also contain a redox initiator system to facilitate the polymerization reaction. Such an initiator system will contain an oxidizer and ascorbic acid, or its salts used as a reducing agent.

Typically, the amount of the oxidizer in the redox initiator system is from about 0.01% to about 2.0% by weight, preferably from about 0.02% to about 1.0% by weight, and more preferably from about 0.025% to about 0.5% by weight, based on total weight of comonomers.

Suitable oxidizers include, benzoyl peroxide, lauryl peroxide, t-butyl peroxide, 2,2′-azobisisobutyronitrile, t-amyl hydroperoxide, t-butyl peroxypivalate, hydrogen peroxide and persulfates, perborates, peracetic acids, peroxides or percarbonates of ammonium or alkali metals. The most preferred oxidizer for the initiator systems of the invention is t-butyl hydroperoxide.

The redox initiator systems herein also contain a reducing agent based on one or more sulfinic acids, ascorbic acid or salts thereof. Typically, the amount of used reducing agents is from about 0.01% to about 2.0% by weight, preferably from about 0.02% to about 1.0% by weight, and more preferably from about 0.025% to about 0.5% by weight, based on total weight of comonomers.

Polymerization Procedures and Conditions

The copolymer dispersions stabilized with polyvinyl alcohols in the invention can be prepared using emulsion polymerization procedures. Such preparation of aqueous polymer dispersion of this type is well known and has already been described in many examples, therefore is known to the technicians in this field. Such procedures are described, for example, in U.S. Pat. No. 5,633,334, and in Encyclopedia of Polymer Science and Engineering, Vol. 8, p. 659 (1987). The disclosures of both of these publications are incorporated herein by reference in entirety.

The polymerization may be carried out in any manner known in one, two or more stages with different monomer combinations, giving polymer dispersions having particles with homogeneous or heterogeneous (e.g., core shell or hemispheres) morphology. Any reaction system such as intermittent, loop, continuous and cascade could be employed.

The polymerization temperature generally range from about 20° C. to about 150° C., preferably from about 50° C. to about 120° C. The polymerization generally takes place under pressure, preferably from about 2 to about 150 bar, more preferably from about 5 to about 100 bar.

In a typical polymerization procedure involving, for example, vinyl acetate/ethylene copolymer dispersions, the vinyl acetate, ethylene, stabilizing system and other co-monomers can be polymerized in an aqueous medium under pressures of up to about 120 bar in the presence of one or more initiators. The aqueous reaction mixture in the polymerization vessel can be maintained at a pH of about 2 to about 7 by a suitable buffering agent.

The manner of combining the several polymerization ingredients, i.e., stabilizing system, comonomers, initiator system components, etc., can vary widely. Generally an aqueous medium containing at least part of the stabilizing system can be initially formed in a polymerization vessel with the various other polymerization ingredients being added to the vessel thereafter.

Co-monomers can be added to the polymerization vessel continuously, incrementally or as a single addition of the entire amounts of comonomers to be used. Comonomers can be employed as pure monomers or can be used in the form of a pre-mixed emulsion. Ethylene as a comonomer can be pumped into the polymerization vessel which is maintained under appropriate pressure.

The whole redox initiator system could be included in the initial charge to the reactor at the beginning of the polymerization. Preferably, part of the initiator is included in the initial charge at the beginning, and the remainder is added in one or more steps or continuously after the polymerization has been initiated.

Characteristics of Aqueous Polymer Dispersions

Unless otherwise specified, the Brookfield viscosity herein is measured at 25° C. using Brookfield viscometer RVDV-II+P with spindle #4 at 20 rpm (the test conditions may be abbreviated as BFV 4#/20 rpm/25° C.).

The Brookfield viscosity of the aqueous polymer dispersion in the invention is greater than or equal to 2,000 mPa·s, preferably 2,000-6,000 mPa·s, and more preferably 2,000-5,000 mPa·s.

Adhesive Combinations

The adhesive combinations in the invention contain the aqueous vinyl ester/ethylene polymer dispersions described herein and the additives combination which are typically used in the production of dispersion-based adhesives. Suitable additives include, for example, film-forming aids, such as white solvent oil, Texanol®, TxiB®, butyl glycol, butyl diethylene glycol, butyldipropylene glycol, and butyltripropylene glycol, toluene; plasticizers, such as dimethyl phthalate, dibutyl phthalate, diisobutyl phthalate, diisobutyl adipate, Coasol B®, Plastilit 3060®, and Triazetin®; wetting agents, such as AMP 90®, TegoWet.280®, Fluowet PE®; thickeners, such as polyacrylates or polyurethanes, such as Borchigel L759® and Tafigel PUR 60®; defoamers, such as mineral oil defoamers or silicone defoamers; UV protective agent, such as Tinuvin 1130®, subsequently added stabilizing polymers, such as polyvinyl alcohol or cellulose ethers, and other additives and auxiliaries of the typical kind for the formulation of adhesives.

The mass fraction of the above-mentioned additives in the final adhesives combination can be up to 25% by weight, preferably from 2% to 15% by weight and especially from 5% to 10% by weight, based on the aqueous polymer dispersion.

### DETAILED DESCRIPTION OF THE PREFERRED EMBODIMENTS

Test Methods

### Solids Content

Solids content is measured by drying 1-2 g of the aqueous polymer dispersion at 105° C. for 1 hour, and got by using the weight of the dried substance divided by the weight of the dispersion.

Brookfield Viscosity

BFV 4#/20 rpm/25° C.

Glass Transition Temperature

The glass transition temperature (Tg) is determined according to ASTM E1356, by differential scanning calorimetry (DSC), using Mettler DSC820 with a liquid N₂ cooling system. The test range is −80° C.˜130° C. at a heating rate of 10° C./min. The Tg value herein is the mid-point of the Tg measured of the dried substance of aqueous polymer dispersions.

HAAKE rheological curve

Equipment used: Thermo HAAKE, RheoStress 600;

Rotor type: Rotor C35/2, #222-1269, Cone with d-35 mm, angle 2 DEG;

Test temperature: 25° C.;

Test range: shear rate from 0 to 800 s⁻¹;

Shear rate change: the shear rate increases continuously linearly from 0 to 800 s⁻¹ during the time from 0 to 300 s, and by then decreases from 800 s⁻¹ to 0 in the same trend.

### EXAMPLES

Preparation of Vinyl Acetate/Ethylene Copolymer Dispersions

### Example 1

735.91 g of a 20% aqueous solution of polyvinyl alcohol (BP 04/88, purchased from ChangChun PetroChemical, Co. Ltd.) having a degree of hydrolysis of about 86-89 mol % and a Hoppler viscosity of about 4-5 mPa·s at a concentration of 4% at 20° C. and 119.04 g of a 10.3% aqueous solution of polyvinyl alcohol (BP 17/88, purchased from ChangChun PetroChemical, Co. Ltd.) having a degree of hydrolysis of about 86-89 mol % and a Hoppler viscosity of about 21-26 mPa·s at a concentrations of 4% at 20° C. were added to water while stirring. And then formic acid was added to adjust the pH to approx.4.0, and 4.30 g of 1% aqueous solution of ammonium ferrous sulfate was further added and stirred well to get an initial aqueous solution.

The prepared initial solution and 1906.00 g of vinyl acetate are added into the reactor. After heated, 156.92 g of ethylene was added.

The initiators is added by dropping, wherein the oxidizer was 10% aqueous solution of t-butyl hydroperoxide, and the reducing agent was 5% aqueous solution of sodium ascorbate. The temperature in the reactor was gradually increased to 90° C.

124.45 g ethylene and 476.50 g of vinyl acetate was added during heating. 227.27 g of a 13.3% aqueous solution of BP 04/88 were added. Redox was added after the complete of mononers and PVOH until the pressure was lower than 15 bar. After the reaction completed, the product was cooled down, mixed with bactericide and conditioning water before discharged.

### Example 2

127.68 g of a 20% aqueous solution of polyvinyl alcohol (BP 04/88, purchased from ChangChun PetroChemical, Co. Ltd.) having a degree of hydrolysis of about 86-89 mol % and a Hoppler viscosity of about 4-5 mPa·s at a concentration of 4% at 20° C. and 703.38 g of a 10.3% aqueous solution of polyvinyl alcohol (BP 17/88, purchased from ChangChun PetroChemical, Co. Ltd.) having a degree of hydrolysis of about 86-89 mol % and a Hoppler viscosity of about 21-26 mPa·s at a concentrations of 4% at 20° C. were added to water while stirring. And then formic acid was added to adjust the pH to approx. 4.0, and 7.98 g of 1% aqueous solution of ammonium ferrous sulfate was further added and stirred well to get an initial aqueous solution.

The prepared initial solution and 1704.30 g of vinyl acetate are added in the reactor. The reactor was heated, and 328.30 g of ethylene was added.

The initiators is added by dropping, wherein the oxidizer was 10% aqueous solution of t-butyl hydroperoxide, and the reducing agent was 5% aqueous solution of disodium hydroxysulfinoacetate (Bruggolite® FF6M, purchased from Brüggemann Chemical Incorporates). And the temperature in the reactor was gradually increased to 85° C.

With a controlled reactor pressure of 65 bar, 130.50 g ethylene and 495.90 g of vinyl acetate was added. After the reaction was completed, 884.70 g of a 35% aqueous solution of BP 04/88 was added at 50° C. When cooling down, the product is mixed with bactericide and conditioning water before discharged.

### Example 3

Except for the change of the polyvinyl alcohol added after polymerization to 884.70 g of a 15% aqueous solution of BP 17/88, the aqueous polymer dispersion of Example 3 was prepared in accordance with the procedures of Example 2.

### Example 4

Except for the omission of polyvinyl alcohol BP 17/88, and the change of BP 04/88 to a polyvinyl alcohol (BP 05/88, purchased from ChangChun PetroChemical, Co. Ltd.) having a degree of hydrolysis of about 86-89 mol % and a Hoppler viscosity of about 5-6 mPa·s of at a concentration of 4% at 20° C. in the initial aqueous solution with the deionized water being reduced to 890.12 g; and the change of the main reactive functional solution to a 13.3% aqueous solution of BP 05/88, the aqueous polymer dispersion of Example 4 was prepared in accordance with the procedures of Example 1.

### Example 5

Except for the change of BP 04/88 to a polyvinyl alcohol (BP 05/88, purchased from ChangChun PetroChemical, Co. Ltd.) having a degree of hydrolysis of about 86-89 mol % and a Hoppler viscosity of about 5-6 mPa·s of at a concentration of 4% at 20° C. in the initial aqueous solution with the deionized water being reduced to 761.55 g, and the change of the main reactive functional solution to 302.26 g of a 10% aqueous solution of BP 05/88, the aqueous polymer dispersion of Example 5 was prepared in accordance with the procedures of Example 1.

### Example 6

Except for the change of the polyvinyl alcohols to 674.60 g of a 20% aqueous solution of BP 04/88 and 238.09 g of a 10.3% aqueous solution of BP 17/88 in the initial aqueous solution with deionized water being reduced to 728.82 g, the aqueous polymer dispersion of Example 6 was prepared in accordance with the procedures of Example 1.

### Comparative Example 1

Mainly Prepared According to Ex.2 with Much Lower PVOH dosage.

The additions of ingredients and the characteristics of corresponding aqueous polymer dispersions of Examples 1-6 are presented in Table 1:

TABLE 1

| | | Ex. 1 | Ex. 2 | Ex. 3 | Ex. 4 | Ex. 5 | Ex. 6 | C. Ex. 1 |
|---|---|---|---|---|---|---|---|---|
| Initial feeding | BP 04/88 (g) | 147.18 | 25.54 | 25.54 | | | 134.92 | |
| | BP 05/88 (g) | | | | 147 | 147.18 | | |
| | BP 17/88 (g) | 12.26 | 72.45 | 72.45 | | 12.26 | 24.52 | |
| Polymerizing | BP 04/88 (g) | 30.23 | | | | | 30.23 | |
| | BP 05/88 (g) | | | | 30.23 | 30.23 | | |
| After | BP 04/88 (g) | | 309.25 | | | | | |
| Polymerized | BP 17/88 (g) | | | 132.71 | | | | |
| | Tg (° C.) | 15.0 | 2.4 | 3.3 | 15.3 | 15.1 | 18.5 | 1.6 |
| | Solids content (%) | 59.85 | 51.09 | 52.43 | 59.69 | 59.43 | 59.74 | 55.33 |
| | Brookfield viscosity | 3,450 | 4,570 | 3,720 | 2,385 | 3,570 | 3,980 | 5,200 |
| | (mPa · s) (BVF, | | | | | | | |
| | 4#/20 rpm/25° C.) | | | | | | | |
| | Low molecular | 14.40 | 4.60 | 0.12 | Infinity | 14.40 | 6.74 | 0.70 |
| | weight PVOHs/ | | | | | | | |
| | med-high molecular | | | | | | | |
| | weight PVOHs | | | | | | | |
| | Total amount of | 7.12 | 15.33 | 8.68 | 6.60 | 7.12 | 7.12 | 3.60 |
| | PVOHs/total amount | | | | | | | |
| | of monomers (%) | | | | | | | |

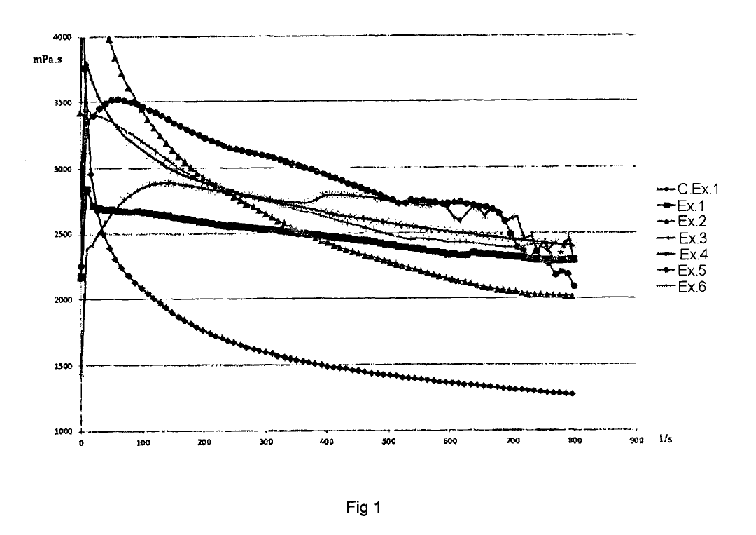

HAAKE rheological curves of the aqueous polymer dispersions of Examples 1-6 and Comparative Example 1 can be seen from the FIG. 1.

in the rheological curve of Example 5, as the shear rate increases continuously from 789.2 s⁻¹ to 799.3 s⁻¹, the viscosities at the endpoints are respectively 2,186 mPa·s and 2,091 mPa·s, based on which the absolute value of the average rate of change in the viscosity of the aqueous polymer dispersion is 9.5;

in the rheological curve of Example 4, as the shear rate increases continuously from 708.1 5⁻¹ to 719.3 s⁻¹, the viscosities at the endpoints are respectively 2,620 mPa·s and 2,453 mPa·s, based on which the absolute value of the average rate of change in the viscosity of the aqueous polymer dispersion is 15;

in the rheological curve of Example 4, as the shear rate increases continuously from 791.4 s⁻¹ to 797.5 s⁻¹, the viscosities at the endpoints are respectively 2,456 mPa·s and 2,281 mPa·s, based on which the absolute value of the average rate of change in the viscosity of the aqueous polymer dispersion is 29.

Accordingly, it is believed that when the shear rate increases continuously from 600 s⁻¹ to 8005⁻¹ and the absolute value of the average rate of change of viscosity is less than or equal to 50, preferably, less than or equal to 30, the rheological curve of the aqueous polymer dispersion is relatively flat, and the viscosity of said aqueous polymer dispersion is relatively stable.

### APPLICATION EXAMPLES

A combination for cigarette adhesives, which can be used in high speed tipping adhesives in the roller process to hold together the filter tip and one end of a paper-wrapped cylindrical cigarette rod.

Prepare an adhesive combination with the following composition and features:

| Components | Part by weight |
|---|---|
| Aqueous polymer dispersions of Example 1 | 100 |
| and Comparative Example 1 | |
| Antifoam agent | 0.1 |
| Plasticizer | 2~3 |
| PVOH, 20 wt. % aqueous solution (BP 17/88) | 20 |
| Water | ~2 |

Solids content: ~50%
Viscosity: ~5,000 mPa · s (BFV 4#/20 rpm/25° C.)

Cigarette machines using cigarette adhesives containing the aqueous polymer dispersion of Comparative Example 1 can run at a maximum speed of only 8,000-9,000 cigarettes/min. There is “splashing” of adhesives when the speed is raised in a higher level.

Cigarette adhesives containing the aqueous polymer dispersion of Example 1 could be used on new high speed cigarette making machines, the run speed of which can reach up to 10,000-16,000 cigarettes/min. The quality of products is very good.

Meanwhile, the quality of products in cigarette cutting step is also good when using the cigarette adhesive containing Ex. 1, which might be the result of higher Tg of the dispersion in Ex. 1. Fewer products adhere to cutting blades.

1. An aqueous polymer dispersion for use in mechanical adhesive applications, comprising:
a monomer mixture comprising:
a vinyl ester, a stabilizing system comprising polyvinyl alcohols and a free radical redox polymerization initiator system, wherein the amount of polyvinyl alcohols in said dispersion is between 6.6 wt. %-35 wt. % based on all the monomers in the dispersion,
wherein said aqueous polymer dispersion is obtained by emulsion copolymerization of the monomer mixture,
wherein said aqueous polymer dispersion further comprises copolymers, including:
a vinyl acetate in an amount of between 50 wt % to 90 wt % of copolymers; and
an ethylene in an amount from 1 wt % to 40 wt % of the total monomers.

2. The dispersion of claim 1, the dispersion has a solid content greater than or equal to 58 wt % based on said dispersion.

3. The dispersion of claim 1, wherein the dispersion has a viscosity that keeps greater than or equal to 2,000 mPa·s as the shear rate increases continuously evenly from 0 to 800 s⁻¹ during the time from 0 to 300 s according to DIN 53019.

4. The dispersion of claim 1, wherein the Brookfield viscosity of the dispersion, measured at 25° C. using Brookfield viscometer RVDV-II+P with spindle #4 at 20 rpm, is greater than or equal to 2,000 mPa·s.

5. The dispersion of claim 1, wherein greater than or equal to 48 wt % of said polyvinyl alcohols, baaed on the total amount of polyvinyl alcohols, are added in an initial feeding step and/or during a polymerizing process.

6. The dispersion of claim 5, wherein 100 wt. % of said polyvinyl alcohols, based on the total amount of polyvinyl alcohols, are added in the initial feeding step and/or the polymerizing process.

7. The dispersion of claim 1, wherein said dispersion is a copolymer of vinyl esters/ethylene dispersion.

8. The dispersion of claim 1, wherein said dispersion further comprises:
1) one or more low molecular weight partially hydrolyzed polyvinyl alcohol having a degree of hydrolysis of 85-95 mol % and a Hoeppler viscosity of 3-6 mPa·s at a concentration of 4% by weight at 25° C.; and
2) one or more medium to high molecular weight partially hydrolyzed polyvinyl alcohols having a degree of hydrolysis of 85-95 mol % and a Hoeppler viscosity of 10-33 mPa·s at a concentration of 4% by weight at 25° C.
wherein the mass ratio of the low molecular w eight polyvinyl alcohols to the medium to high molecular weight polyvinyl alcohols is greater than or equal to 6.5.

9. The dispersion of claim 1, wherein dried portions of said aqueous polymer dispersion have a Tg of 12° C.˜18.5° C.

10. An adhesive according to claim 1, wherein said adhesive is used in the manufacturing of cigarettes.
